(19) United States
(12) Patent Application Publication
(10) Pub. No.: US 2023/0358893 A1
(43) Pub. Date: Nov. 9, 2023

(54) OPTICAL ILLUMINATION FOR ROAD OBSTACLE DETECTION

(71) Applicant: Cepton Technologies, Inc., San Jose, CA (US)

(72) Inventors: Jun Pei, Saratoga, CA (US); Mark A. McCord, Los Gatos, CA (US)

(73) Assignee: Cepton Technologies, Inc., San Jose, CA (US)

(21) Appl. No.: 18/142,329

(22) Filed: May 2, 2023

Related U.S. Application Data
(60) Provisional application No. 63/337,681, filed on May 3, 2022.

(51) Int. Cl. G01S 17/931; G01S 7/481

(52) U.S. Cl. CPC G01S 17/931; G01S 7/4813; G01S 7/4817; G01S 17/10

(57) ABSTRACT

A system for detecting road debris using LiDAR includes an illumination module and a detection module. The illumination module and the detection module are arranged on a vehicle. The illumination module in contained in a first housing, and the detection module is contained in a second housing. The first housing is separated from the second housing so that the detection module is offset from the illumination module.

### CROSS-REFERENCES TO RELATED APPLICATIONS

This application claims the benefit of U.S. Provisional Patent Application No. 63/337,681, filed on May 3, 2022, the contents of which is hereby incorporated by reference in its entirety.

### BACKGROUND

Three-dimensional (3D) sensors can be applied in various applications, including in autonomous or semi-autonomous vehicles, drones, robotics, security applications, and the like. LiDAR sensors are a type of 3D sensor that can achieve high angular resolutions appropriate for such applications. A LiDAR sensor can include one or more laser sources for emitting laser pulses and one or more detectors for detecting reflected laser pulses. A LiDAR sensor can measure the time it takes for each laser pulse to travel from the LiDAR sensor to an object within the sensor's field of view, then reflect off the object and return to the LiDAR sensor. The LiDAR sensor can calculate a distance how far away the object is from the LiDAR sensor based on the time of flight of the laser pulse. Some LiDAR sensors can calculate distance based a phase shift of light. By sending out laser pulses in different directions, the LiDAR sensor can build up a three-dimensional (3D) point cloud of one or more objects in an environment.

### SUMMARY

In certain embodiments, system for detecting road debris using LiDAR comprises an illumination module and a detection module. The illumination module is positioned on a vehicle; the illumination module is contained within a first housing; the illumination module comprises a light source arranged to transmit light toward the ground a predetermined distance in front of the vehicle; the detection module is positioned on the vehicle; the detection module is contained within a second housing; the second housing is physically separate from the first housing so that the detection module is offset from the illumination module; and/or the detection module is arranged to detect light from the light source after light from the light source is transmitted in front of the vehicle. In certain embodiments, a system for detecting road debris using LiDAR comprises a first illumination module, second illumination module, and a detection module. The first illumination module is positioned on a vehicle; the first illumination module comprises a first light source arranged to transmit light toward the ground a first predetermined distance in front of the vehicle; the first light source is a laser; the second illumination module is positioned on the vehicle; the second illumination module comprises a second light source arranged to transmit light toward the ground a second predetermined distance in front of the vehicle; the second light source is a laser; the second predetermined distance is different from the first predetermined distance; the detection module is positioned on the vehicle; and/or the detection module is arranged to detect light from the first light source and/or the second light source after light from the first light source and/or the second light source is transmitted in front of the vehicle.

In some embodiments, the detection module is positioned on the vehicle to be vertically offset from the illumination module; the detection module is above the illumination module; the detection module is below the illumination module; the detection module is positioned on the vehicle to be horizontally offset from the illumination module: the light source is a first light source; the detection module comprises a second light source; the second light source and the detection module form a LiDAR sensor system; the illumination module is arranged to rotate vertically to follow an elevation of a road; the light source is arranged to project a fan-shaped illumination pattern; the light source is arranged to be scanned horizontally to produce the fan-shaped illumination pattern; the light source is arranged to horizontally rotate the fan-shaped illumination pattern to follow a road; a width of the fan-shaped illumination pattern on the ground is arranged to be equal to or greater than 8 feet and equal to or less than 16 feet; the illumination module is a first illumination module; the system comprises a second illumination module arranged on the vehicle; the second illumination module is arranged to point at a different distance in front of the vehicle than the first illumination module; the second illumination module is arranged at a different height on the vehicle than the first illumination module; the second illumination module has a field of view with a different angular extent than a field of view of the first illumination module; the second illumination module is vertically offset from the first illumination module; and/or the detection module is positioned on the vehicle to be vertically offset from the first illumination module and the second illumination module.

In certain embodiments, a method for detecting road debris using LiDAR comprises transmitting light toward the ground a predetermined distance in front of a vehicle and detecting light from the light source. Light is transmitted using a light source that is part of an illumination module; the illumination module is positioned on the vehicle; the illumination module is contained within a first housing; light from the light source is detected after light from the light source is transmitted in front of the vehicle; light is detected using a detection module; the detection module is positioned on the vehicle; the detection module is contained within a second housing; and/or the second housing is physically separate from the first housing so that the detection module is offset from the illumination module. In some embodiments, the method comprises calculating a distance to an object in front of the vehicle based on detecting light from the light source, and/or the light source is a laser.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 illustrates an embodiment of a LiDAR sensor for three-dimensional imaging.

FIG. 2 depicts a diagram of light from an embodiment of a sensor used for detecting road obstacles.

FIG. 3 depicts an embodiment of a field of view of an illumination source.

FIG. 4 depicts an embodiment of a system for using LiDAR to detect road debris.

FIG. 5 depicts an embodiment of a system with multiple illumination zones.

FIG. 6 depicts an embodiment of a forward-looking view showing multiple illumination zones.

FIG. 7 depicts an embodiment of multiple illumination modules.

FIG. 8 depicts an embodiment of an illumination module rotating horizontally.

FIG. 9 depicts an embodiment of an illumination module rotating vertically.

FIG. 10 illustrates a flowchart of an embodiment of a process for using LiDAR to detect road debris.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

In some configurations, a reliable and long-range technique for detecting road obstacles such as tires, debris, and potholes is important (e.g., in advanced driver assistance systems (ADAS) and autonomous vehicles). Obstacles that are too small to be easily detected by existing sensors, such as radar, cameras, or LiDAR, may nonetheless be large enough to cause vehicle damage or accidents when encountered at highway speeds. By using glancing angle illumination, a signal from an obstacle can be enhanced while clutter from other objects, such as the ground, can be reduced or minimized. By adding targeted scan patterns and customized laser illumination profiles, the signal can be further enhanced while continuing to reduce or minimize clutter and extraneous information. The illumination may be designed to work with an existing LiDAR sensor (e.g., as a supplemental source of targeted illumination).

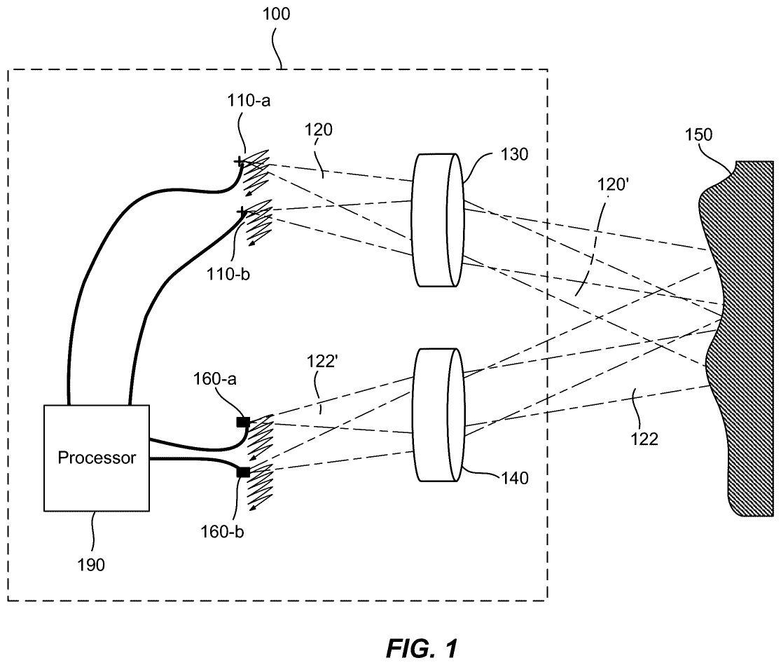

FIG. 1 illustrates an embodiment of a LiDAR sensor 100 for three-dimensional imaging. The LiDAR sensor 100 includes an emission lens 130 and a receiving lens 140. The LiDAR sensor 100 includes a light source 110-a disposed substantially in a back focal plane of the emission lens 130. The light source 110-a is operative to emit a light pulse 120 from a respective emission location in the back focal plane of the emission lens 130. The emission lens 130 is configured to collimate and direct the light pulse 120 toward an object 150 located in front of the LiDAR sensor 100. For a given emission location of the light source 110-a, the collimated light pulse 120′ is directed at a corresponding angle toward the object 150.

A portion 122 of the collimated light pulse 120′ is reflected off of the object 150 toward the receiving lens 140. The receiving lens 140 is configured to focus the portion 122′ of the light pulse reflected off of the object 150 onto a corresponding detection location in the focal plane of the receiving lens 140. The LiDAR sensor 100 further includes a detector 160-a disposed substantially at the focal plane of the receiving lens 140. The detector 160-a is configured to receive and detect the portion 122′ of the light pulse 120 reflected off of the object at the corresponding detection location. The corresponding detection location of the detector 160-a is optically conjugate with the respective emission location of the light source 110-a.

The light pulse 120 may be of a short duration, for example, 10 ns pulse width. The LiDAR sensor 100 further includes a processor 190 coupled to the light source 110-a and the detector 160-a. The processor 190 is configured to determine a time of flight (TOF) of the light pulse 120 from emission to detection. Since the light pulse 120 travels at the speed of light, a distance between the LiDAR sensor 100 and the object 150 may be determined based on the determined time of flight.

One way of scanning the laser beam 120′ across a FOV is to move the light source 110-a laterally relative to the emission lens 130 in the back focal plane of the emission lens 130. For example, the light source 110-a may be raster scanned to a plurality of emission locations in the back focal plane of the emission lens 130 as illustrated in FIG. 1. The light source 110-a may emit a plurality of light pulses at the plurality of emission locations. Each light pulse emitted at a respective emission location is collimated by the emission lens 130 and directed at a respective angle toward the object 150, and impinges at a corresponding point on the surface of the object 150. Thus, as the light source 110-a is raster scanned within a certain area in the back focal plane of the emission lens 130, a corresponding object area on the object 150 is scanned. The detector 160-a may be raster scanned to be positioned at a plurality of corresponding detection locations in the focal plane of the receiving lens 140, as illustrated in FIG. 1. The scanning of the detector 160-a is typically performed synchronously with the scanning of the light source 110-a, so that the detector 160-a and the light source 110-a are always optically conjugate with each other at any given time.

By determining the time of flight for each light pulse emitted at a respective emission location, the distance from the LiDAR sensor 100 to each corresponding point on the surface of the object 150 may be determined. In some embodiments, the processor 190 is coupled with a position encoder that detects the position of the light source 110-a at each emission location. Based on the emission location, the angle of the collimated light pulse 120′ may be determined. The X-Y coordinate of the corresponding point on the surface of the object 150 may be determined based on the angle and the distance to the LiDAR sensor 100. Thus, a three-dimensional image of the object 150 may be constructed based on the measured distances from the LiDAR sensor 100 to various points on the surface of the object 150. In some embodiments, the three-dimensional image may be represented as a point cloud, i.e., a set of X, Y, and Z coordinates of the points on the surface of the object 150.

In some embodiments, the intensity of the return light pulse 122′ is measured and used to adjust the power of subsequent light pulses from the same emission point, in order to prevent saturation of the detector, improve eye-safety, or reduce overall power consumption. The power of the light pulse may be varied by varying the duration of the light pulse, the voltage or current applied to the laser, or the charge stored in a capacitor used to power the laser. In the latter case, the charge stored in the capacitor may be varied by varying the charging time, charging voltage, or charging current to the capacitor. In some embodiments, the reflectivity, as determined by the intensity of the detected pulse, may also be used to add another dimension to the image. For example, the image may contain X, Y, and Z coordinates, as well as reflectivity (or brightness).

The angular field of view (AFOV) of the LiDAR sensor 100 may be estimated based on the scanning range of the light source 110-a and the focal length of the emission lens 130 as,

$$AFOV = 2 {tan}^{- 1} ( \frac{h}{2 f} ) ,$$

where h is scan range of the light source 110-a along certain direction, and f is the focal length of the emission lens 130. For a given scan range h, shorter focal lengths would produce wider AFOVs. For a given focal length f, larger scan ranges would produce wider AFOVs. In some embodiments, the LiDAR sensor 100 may include multiple light sources disposed as an array at the back focal plane of the emission lens 130, so that a larger total AFOV may be achieved while keeping the scan range of each individual light source relatively small. Accordingly, the LiDAR sensor 100 may include multiple detectors disposed as an array at the focal plane of the receiving lens 140, each detector being conjugate with a respective light source. For example, the LiDAR sensor 100 may include a second light source 110-b and a second detector 160-b, as illustrated in FIG. 1. In other embodiments, the LiDAR sensor 100 may include four light sources and four detectors, or eight light sources and eight detectors. In one embodiment, the LiDAR sensor 100 may include eight light sources arranged as a 4×2 array and eight detectors arranged as a 4×2 array, so that the LiDAR sensor 100 may have a wider AFOV in the horizontal direction than its AFOV in the vertical direction. According to various embodiments, the total AFOV of the LiDAR sensor 100 may range from about 5 degrees to about 15 degrees, or from about 15 degrees to about 45 degrees, or from about 45 degrees to about 120 degrees, depending on the focal length of the emission lens, the scan range of each light source, and the number of light sources.

The light source 110-a may be configured to emit light pulses in the near infrared wavelength ranges. The energy of each light pulse may be in the order of microjoules, which is normally considered to be eye-safe for repetition rates in the kHz range. For light sources operating in wavelengths greater than about 1500 nm (in the near infrared wavelength range), the energy levels could be higher as the eye does not focus at those wavelengths. The detector 160-a may comprise a silicon avalanche photodiode, a photomultiplier, a PIN diode, or other semiconductor sensors.

Additional LiDAR sensors are described in commonly owned U.S. patent application Ser. No. 15/267,558 filed Sep. 15, 2016, Ser. No. 15/971,548 filed on May 4, 2018, Ser. No. 16/504,989 filed on Jul. 8, 2019, Ser. No. 16/775,166 filed on Jan. 28, 2020, Ser. No. 17/032,526 filed on Sep. 25, 2020, Ser. No. 17/133,355 filed on Dec. 23, 2020, Ser. No. 17/205,792 filed on Mar. 18, 2021, and Ser. No. 17/380,872 filed on Jul. 20, 2021, the disclosures of which are incorporated by reference for all purposes.

It can be desirable to detect road obstacles, such as tires, up to 200 m to 300 m in front of a vehicle to allow for safe maneuvering or stopping at highway speeds (e.g., to avoid a collision). Such obstacles can be extremely difficult to detect by conventional sensors such as cameras, radar, or LiDAR, since they often have poor reflectivity (e.g., especially tires) and signals may be obscured by ground clutter noise.

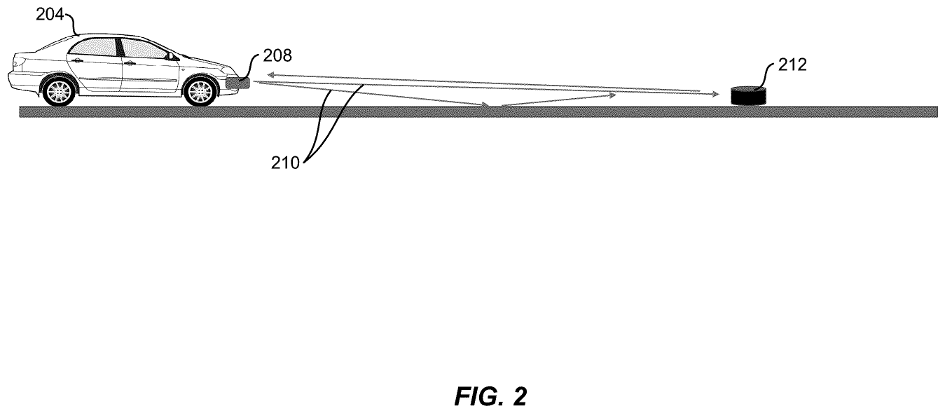

FIG. 2 depicts a diagram of light from an embodiment a sensor used for detecting road obstacles, such as debris. FIG. 2 depicts a vehicle 204 with a sensor 208 integrated with (e.g., positioned on) the vehicle 204. For example, the sensor 208 is a LiDAR sensor 100 as described in FIG. 1. FIG. 2 shows how light 210 from the sensor 208 will return from an object 212 of interest (e.g., debris), but light striking the road surface will largely scatter away from the sensor when illuminated at a glancing angle. This can allow for better detection of road debris relative to the road surface.

The sensor 208 may be advantageously placed low to the ground for road debris detection, for example in a bumper of the vehicle 204. The sensor 208 may be a type of camera or a type of LiDAR. By illuminating the road surface at a glancing angle, most of the light hitting the road surface will reflect in a forward direction, away from the sensor 208. This reduces the intensity of ground returns that might otherwise obscure road debris.

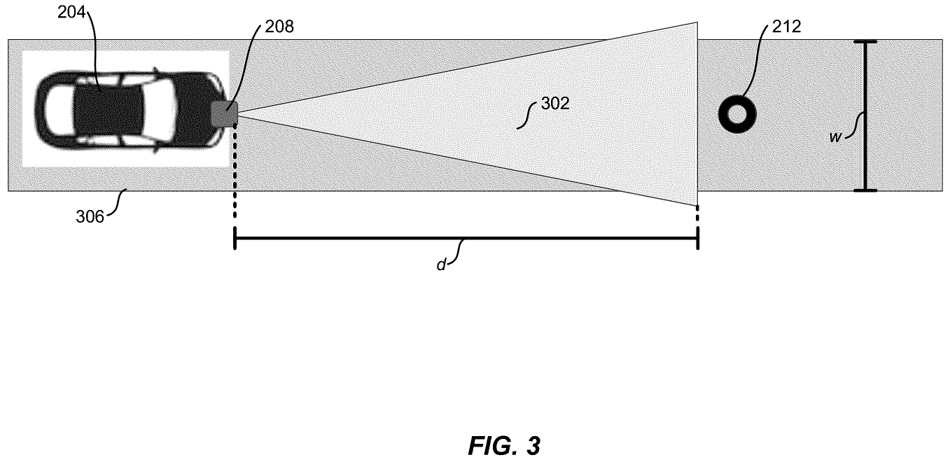

FIG. 3 depicts an embodiment of a field of view of an illumination source. FIG. 3 depicts a top view of the vehicle 204. The illumination source is part of the sensor 208. The illumination source comprises a light source. The illumination source produces an illumination pattern 302. The illumination pattern 302 illuminates a certain region of interest. For example, the illumination source may be optically arranged so the illumination pattern 302 is a fan shape covering a width w of the road 306 and/or striking the road surface at a predetermined distance d (e.g., a maximum distance or a range of distances) in front of the vehicle 204. This allows the object 212 in the path of the vehicle 204 to be sensed without having to scan the illumination. In some embodiments, d is equal to or greater than 50 meters and equal to or less than 300 meters. In some embodiments, illumination does not extend beyond the predetermined distance d.

In some embodiments, the illumination source may be much finer in its angular extent, but include a scanning mechanism in the horizontal and/or vertical direction so that the region of interest is fully illuminated. Thus, a light source can be arranged to be scanned horizontally to produce the fan-shaped illumination pattern. The sensor 208 may have a lens that concentrates the returned photons onto a single photodetector, possibly without the use of scanning or imaging. In this case, if high resolution is desired, then that can be provided by a finely focused illumination source. In some embodiments, the system may have a lens that images the photons onto a 1-dimensional or 2-dimensional array of photodetectors and/or a silicon imaging sensor such as a camera chip. If the illumination is scanned, the return light may be scanned across the photodetector(s) synchronously with the illumination. The return signal may be further processed to give time-of-flight and/or phase difference information that can be converted to a distance (e.g., such as a LiDAR sensor does).

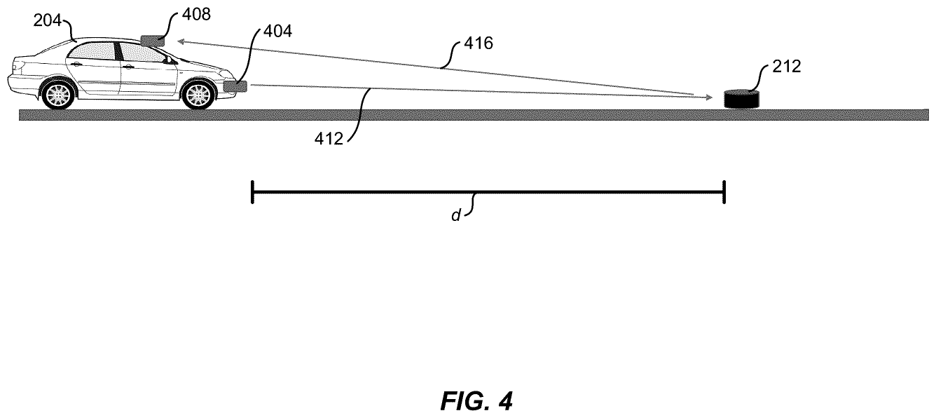

FIG. 4 depicts an embodiment of a system for using LiDAR to detect road debris. The system comprises an illumination module 404 and a detection module 408. The illumination module 404 is positioned on the vehicle 204 and contained in a first housing. The illumination module 404 can comprise one or more illumination sources. The illumination module 404 comprises a light source arranged to transmit light 412 toward the ground a predetermined distance din front of the vehicle 204.

The detection module 408 is positioned on the vehicle 204 and contained within a second housing. The second housing is physically separate from the first housing so that the detection module 408 is offset from the illumination module 404. In some embodiments, the first housing is separated from the second housing (or a source is separated from a detector) by a distance equal to or greater than 0.15, 0.3, 0.5, 0.75, 1, or 1.5 meters and/or equal to or less than 1.5, 2, or 3 meters. The detection module 408 is arranged to detect reflected light 416 from the light source after light 412 from the light source is transmitted in front of the vehicle 204 (e.g., and reflected by object 212).

In FIG. 4, the detection module 408 is positioned on the vehicle 204 to be vertically offset from the illumination module 404 (e.g., the detection module 408 is above the illumination module 404 in relation to gravity). In some embodiments, the detection module 408 is below the illumination module 404. In some embodiments, the detection module 408 is horizontally offset form the illumination module 404 (e.g., in addition to or in lieu of vertical offset).

In some embodiments, the detection module 408 is separated from the illumination module 404 in order to provide better discrimination between debris or other elements of the road surface, such as lane markers. The detection module 408 may, in some embodiments, be an independently functioning LiDAR unit. For example, the light source is a first light source; the detection module 408 comprises a second light source; and the second light source and the detection module 408 form a LiDAR sensor system. The illumination module 404 may provide supplemental illumination to the LiDAR sensor system for better and/or longer-range detection. Separating the detection module 408 from the illumination module 404 can be analogous to darkfield detection in microscopy (e.g., to reduce or minimize detection of specular reflection and enhance scattered light detection). By separating illumination and detection, a number of photons (e.g., signal strength) from objects such as road debris can be enhanced relative to other objects such as the roadway surface. For example, separating the detection module 408 from the illumination module 404 may allow for improved discrimination between road debris and retro-reflective objects such as road lane markers. This is because retro-reflectors reflect light preferentially back toward an illumination source. Some configurations include putting the illumination module 404 near the roof of the vehicle 204 and the detection module 408 near the bumper, or putting the illumination module 404 on one side of the vehicle 204 (e.g., in bumper or headlamp) and the detection module 408 on the other side of the vehicle 204 (e.g., in the bumper or a second headlamp). The positions of the illumination module 404 and the detection module 408 may be swapped in some implementations (e.g., due to packaging or other considerations). Though the illumination module 404 and the detection module 408 are shown separated, the illumination module 404 and the detection module 408 can be in the same house in some embodiments (e.g., as the sensor 208 in FIG. 2).

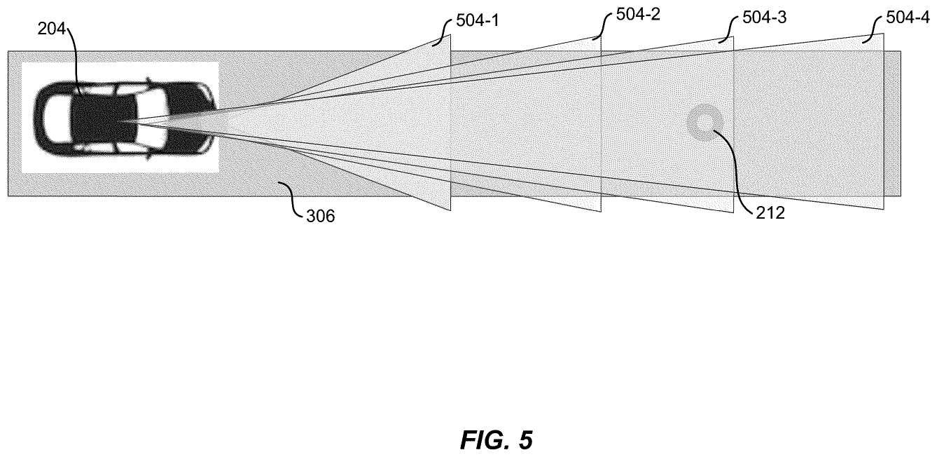

FIG. 5 depicts an embodiment of a system with multiple illumination zones 504. Illumination sources may be divided into multiple illumination zones 504, each illumination zone 504 optimized for a portion of the road 306 at which the illumination zone 504 is aiming.

FIG. 5 depicts a first illumination zone 504-1, a second illumination zone 504-2, a third illumination zone 504-3, and a fourth illumination zone 504-4, with the first illumination zone 504-1 being closer to the vehicle 204 than the fourth illumination zone 504-4. The second illumination zone 504-2 illuminates farther than the first illumination zone 504-1. The third illumination zone 504-3 illuminates farther than the second illumination zone 504-2. The fourth illumination zone 504-4 illuminates farther than the third illumination zone 504-3.

As the road 306 is viewed farther ahead from the vehicle 204, the perspective causes the road to shrink in terms of horizontal angular extent. Therefore, it may be advantageous for the second illumination zone 504-2 to be concentrated in a narrower band than the first illumination zone 504-1 (and likewise for the third illumination zone 504-3 and the fourth illumination zone 504-4) to reduce or eliminate illuminating parts of the environment that are not drivable. Accordingly, a first illumination module comprising a first illumination source can have a field of view with a different angular extent than a field of view of a second illumination module comprising a second illumination source. In some embodiments, an illumination source may generate a single trapezoidal pattern or may be divided into different zones with different angular extent.

An illumination source or sources may be synchronized with an existing camera or LiDAR sensor, providing additional targeted illumination in regions where a normal LiDAR sensor system is inadequate or less capable. In a LiDAR setup, synchronization may be accurate to a nanosecond scale to allow for accurate distance calculation from a time of flight of light.

In some LiDAR sensors, laser pulse power may be limited by eye-safety requirements. In some embodiments, a LiDAR sensor may incorporate high-power lasers that are fired (or fired at high power) only when the high-power laser is aimed at a specific region, such as a portion of the road 306 where the sensor is looking for debris. By this technique, an average laser power can be maintained within eye-safe limits while still providing for higher power levels used for debris detection.

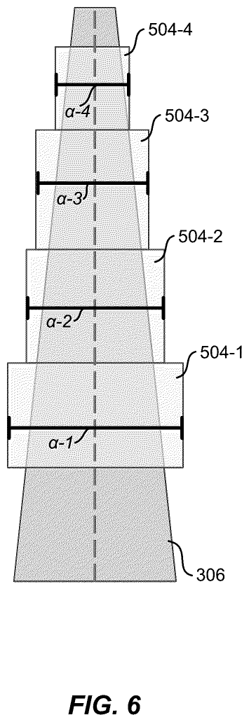

Different illumination zones 504 with different angular extents is shown in FIG. 5 in a top-down view. FIG. 6 depicts an embodiment of a forward-looking view showing multiple illumination zones 504 from a perspective of a driver's position of the vehicle 204. The farther forward-looking illumination zones 504 are concentrated into smaller horizontal angular extents α.

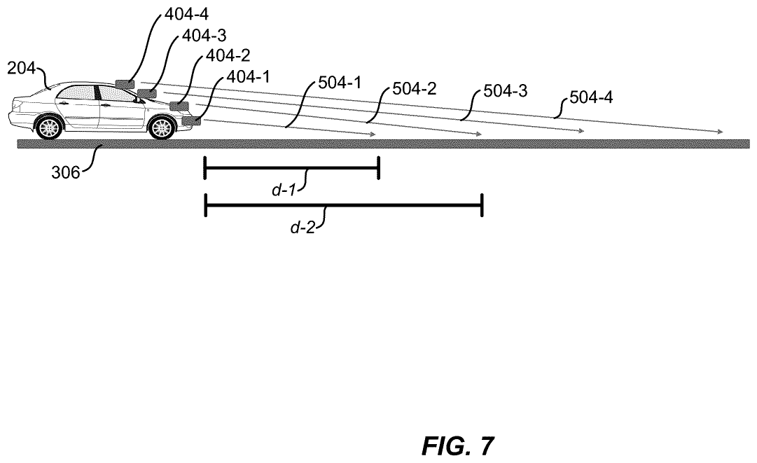

FIG. 7 depicts an embodiment of multiple illumination modules 404 arranged on the vehicle 204 for multiple illumination zones 504. Light for each illumination zone 504 may originate from a separate illumination module 404. An illumination module 404 can be placed at an optimal height above the roadway. Illumination sources for farther ahead portions of the road 306 may be placed higher on the vehicle 204 in order to maintain an improved or optimal intercept angle with the road surface. A first illumination module 404-1 is used to illuminate the first illumination zone 504-1. A second illumination module 404-2 is used to illuminate the second illumination zone 504-2. A third illumination module 404-3 is used to illuminate the third illumination zone 504-3. A fourth illumination module 404-4 is used to illuminate the fourth illumination zone 504-4.

Each illumination zone 504 can be optimized for a distance d and/or roadway section. For example, the first illumination module 404-1 is arranged to point at a first distance d-1 on the road 306 in front of the vehicle 204. The second illumination module 404-2 is arranged to point at a second distance d-2 on the road 306 in front of the vehicle 204. The second illumination module 404-2 is arranged to point at a different distance in front of the vehicle than the first illumination module. For example, the first distance d-1 is shorter than the second distance d-2. The second illumination module 404-2 is arranged at a different height (e.g., higher) on the vehicle 204 than the first illumination module 404-1.

In some embodiments, a system for detecting road debris comprises a first illumination module, a second illumination module, and a detection module. The first illumination module is positioned on the vehicle 204. The first illumination module comprises a first light source (e.g., a laser) arranged to transmit light toward the ground a first predetermined distance in front of the vehicle. The second illumination module is positioned on the vehicle 204. The second illumination module comprises a second light source (e.g., a laser) arranged to transmit light toward the ground a second predetermined distance in front of the vehicle. The second predetermined distance is different from the first predetermined distance (e.g., d-2 is different than d-1). The detection module is positioned on the vehicle 204. The detection module is arranged to detect light from the first light source and/or the second light source, after light from the first light source and/or the second light source is transmitted in front of the vehicle. For example, a detection module could detect light from both light sources (e.g., the detection module is co-located with the fourth illumination module 404-4), or the detection module could be one of a plurality of detection modules (e.g., a first detection module is co-located with the second illumination module 404-2; a second detection module is co-located with the first illumination module 404-1; the first detection module is used to detect light from the first illumination module; and the second detection module is used to detect light from the second illumination module). In some configurations, the second illumination module is vertically offset from the first illumination module, and the detection module is positioned on the vehicle to be vertically offset from both the first illumination module and the second illumination module.

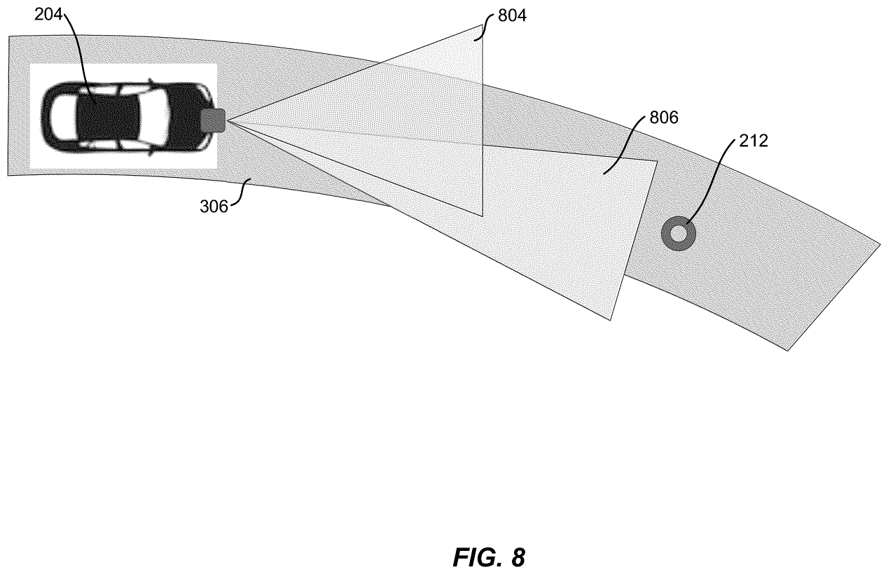

FIG. 8 depicts an embodiment of an illumination module rotating horizontally. FIG. 8 shows illumination being rotated horizontally in order to follow a curvature of the road 306. The illumination source has the capability to rotate and/or scan horizontally according to a curvature of the road 306 (and/or an amount of turning of the vehicle 204) relative to an orientation of the vehicle 204.

In FIG. 8, an illumination pattern 804 and a rotated illumination pattern 806 are shown. A light source of an illumination module is arranged to horizontally rotate and/or extend the illumination pattern 804 to follow a road. In some embodiments, a width of a fan-shaped illumination pattern on the ground is arranged to be equal to a width of the road 306. For example, the width of the fan-shaped illumination is equal to or greater than 8 feet and/or equal to or less than 16 feet.

Because rotational motion of illumination is relatively slow compared to scanning used to achieve typical sensor frame rates, it may be accomplished with a relatively simple and low power mechanism (e.g., using a mirror on a gimbal mount). A direction of illumination may be computed from the vehicle GPS coordinates and road maps, from analysis of on-board camera or lidar images, and/or from one or more sensors on the vehicle used to detect turning of a steering wheel and/or a wheel.

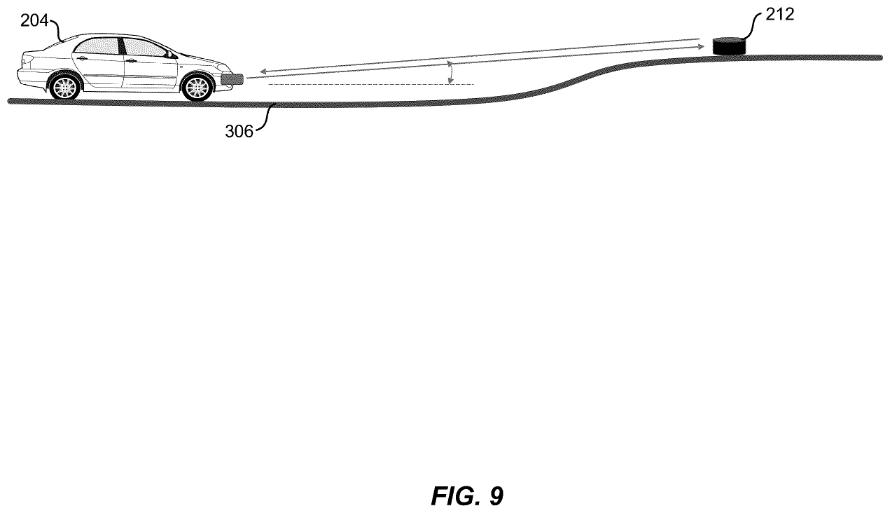

FIG. 9 depicts an embodiment of an illumination module rotating vertically. The illumination module is arranged to rotate vertically to follow an elevation of a road 306. Vertical rotation may be incorporated to account for hills or dips in the road. In some embodiments, vertical rotation may be used to account for varying speed of the vehicle. For example, the illumination module rotates to a farther maximum distance as the vehicle increases speed.

Rotation may be achieved by a variety of optical and/or mechanical techniques. These can include a rotatable mirror placed in front of a collimating lens; moving an illumination source with a linear or arc motion behind the collimating lens; and/or rotating the illumination source and the collimation lens together as a rigid body, by mounting them as a structure on a rotational axis or gimbal. The mechanical motion may be driven by a motor, a stepper motor, a linear motor, a voice coil, a piezoelectric actuator, or other actuators or motors.

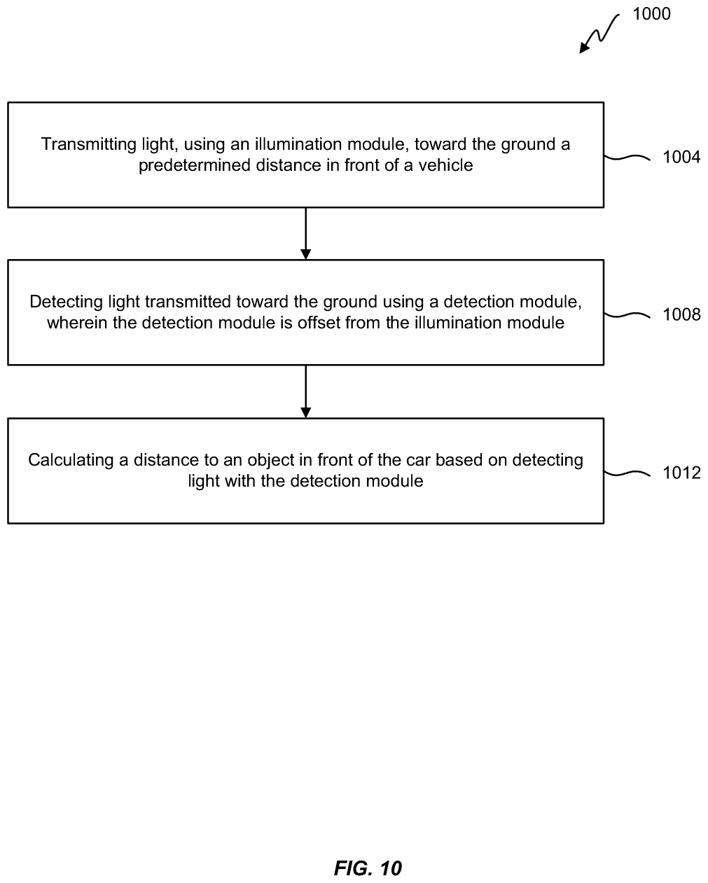

FIG. 10 illustrates a flowchart of an embodiment of a process 1000 for using LiDAR to detect road debris. Process 1000 begins in step 1004 with transmitting light toward the ground a predetermined distance in front of a vehicle (e.g., as shown in FIGS. 2-7). Light is transmitted using a light source that is part of an illumination module. The illumination module is positioned on the vehicle. The illumination module is contained within a first housing.

In step 1008, light from the light source is detected, using a detection module, after light from the light source is transmitted in front of the vehicle. The detection module is positioned on the vehicle in a second housing. The second housing is physically separate from the first housing so that the detection module is offset from the illumination module.

In step 1012 a distance to an object in front of the vehicle is calculated based on detecting light from the light source. For example, the light source is a laser of a LiDAR system.

Various features described herein, e.g., methods, apparatus, computer-readable media and the like, can be realized using a combination of dedicated components, programmable processors, and/or other programmable devices. Some processes described herein can be implemented on the same processor or different processors. Where some components are described as being configured to perform certain operations, such configuration can be accomplished, e.g., by designing electronic circuits to perform the operation, by programming programmable electronic circuits (such as microprocessors) to perform the operation, or a combination thereof. Further, while the embodiments described above may make reference to specific hardware and software components, those skilled in the art will appreciate that different combinations of hardware and/or software components may also be used and that particular operations described as being implemented in hardware might be implemented in software or vice versa.

Details are given in the above description to provide an understanding of the embodiments. However, it is understood that the embodiments may be practiced without some of the specific details. In some instances, well-known circuits, processes, algorithms, structures, and techniques are not shown in the figures.

While the principles of the disclosure have been described above in connection with specific apparatus and methods, it is to be understood that this description is made only by way of example and not as limitation on the scope of the disclosure. Embodiments were chosen and described in order to explain principles and practical applications to enable others skilled in the art to utilize the invention in various embodiments and with various modifications, as are suited to a particular use contemplated. It will be appreciated that the description is intended to cover modifications and equivalents.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary. Patents, patent applications, publications, and descriptions mentioned here are incorporated by reference in their entirety for all purposes. None is admitted to be prior art.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to explain the principles of the invention and its practical applications to thereby enable others skilled in the art to utilize the invention in various embodiments and with various modifications as are suited to the particular use contemplated.

What is claimed is:

1. A system for detecting road debris using LiDAR, the system comprising:
an illumination module, wherein:
the illumination module is positioned on a vehicle;
the illumination module is contained within a first housing;
the illumination module comprises a light source arranged to transmit light toward the ground a predetermined distance in front of the vehicle; and
a detection module, wherein:
the detection module is positioned on the vehicle;
the detection module is contained within a second housing;
the second housing is physically separate from the first housing so that the detection module is offset from the illumination module; and
the detection module is arranged to detect light from the light source after light from the light source is transmitted in front of the vehicle.

2. The system of claim 1, wherein the detection module is positioned on the vehicle to be vertically offset from the illumination module.

3. The system of claim 2, wherein the detection module is above the illumination module.

4. The system of claim 2, wherein the detection module is below the illumination module.

5. The system of claim 1, wherein the detection module is positioned on the vehicle to be horizontally offset from the illumination module.

6. The system of claim 1, wherein:
the light source is a first light source;
the detection module comprises a second light source; and
the second light source and the detection module form a LiDAR sensor system.

7. The system of claim 1, wherein the illumination module is arranged to rotate vertically to follow an elevation of a road.

8. The system of claim 1, wherein the light source is arranged to project a fan-shaped illumination pattern.

9. The system of claim 8, wherein the light source is arranged to be scanned horizontally to produce the fan-shaped illumination pattern.

10. The system of claim 8, wherein the light source is arranged to horizontally rotate the fan-shaped illumination pattern to follow a road.

11. The system of claim 8, wherein a width of the fan-shaped illumination pattern on the ground is arranged to be equal to or greater than 8 feet and equal to or less than 16 feet.

12. The system of claim 1, wherein:
the illumination module is a first illumination module; and
the system comprises a second illumination module arranged on the vehicle.

13. The system of claim 12, wherein the second illumination module is arranged to point at a different distance in front of the vehicle than the first illumination module.

14. The system of claim 12, wherein the second illumination module is arranged at a different height on the vehicle than the first illumination module.

15. The system of claim 12, wherein the second illumination module has a field of view with a different angular extent than a field of view of the first illumination module.

16. A method for detecting road debris using LiDAR, the method comprising:
transmitting light toward the ground a predetermined distance in front of a vehicle, wherein:
light is transmitted using a light source that is part of an illumination module;
the illumination module is positioned on the vehicle; and
the illumination module is contained within a first housing; and
detecting light from the light source, wherein:
light from the light source is detected after light from the light source is transmitted in front of the vehicle;
light is detected using a detection module;
the detection module is positioned on the vehicle;
the detection module is contained within a second housing; and
the second housing is physically separate from the first housing so that the detection module is offset from the illumination module.

17. The method of claim 16, the method further comprising calculating a distance to an object in front of the vehicle based on detecting light from the light source.

18. The method of claim 16, wherein the light source is a laser.

19. A system for detecting road debris using LiDAR, the system comprising:
a first illumination module, wherein:
the first illumination module is positioned on a vehicle;
the first illumination module comprises a first light source arranged to transmit light toward the ground a first predetermined distance in front of the vehicle; and
the first light source is a laser;
a second illumination module, wherein:
the second illumination module is positioned on the vehicle;
the second illumination module comprises a second light source arranged to transmit light toward the ground a second predetermined distance in front of the vehicle;
the second light source is a laser; and
the second predetermined distance is different from the first predetermined distance; and
a detection module, wherein:
the detection module is positioned on the vehicle; and
the detection module is arranged to detect light from the first light source and/or the second light source after light from the first light source and/or the second light source is transmitted in front of the vehicle.

20. The system of claim 19, wherein:
the second illumination module is vertically offset from the first illumination module; and
the detection module is positioned on the vehicle to be vertically offset from the first illumination module and the second illumination module.
